(19) United States
(12) Patent Application Publication
(10) Pub. No.: US 2024/0362067 A1
(43) Pub. Date: Oct. 31, 2024

(54) DIGITAL CONTENT PROCESSING METHOD AND APPARATUS, ELECTRONIC DEVICE, STORAGE MEDIUM AND PRODUCT

(71) Applicant: AISHU TECHNOLOGY CORP., Shanghai (CN)

(72) Inventors: Zhijie Chen, Shanghai (CN); Feng Zhou, Shanghai (CN)

(21) Appl. No.: 18/291,852

(22) PCT Filed: Mar. 8, 2023
(86) PCT No.: PCT/CN2023/080256

§ 371 Date: Jan. 24, 2024

(30) Foreign Application Priority Data
Mar. 15, 2022 (CN) 202210251048.4

(51) Int. Cl. G06F 9/50

(52) U.S. Cl. CPC G06F 9/5027

(57) ABSTRACT

A digital content processing method and a digital content processing apparatus, an electronic device, a storage medium and a product are provided. The digital content processing method includes: acquiring a definition of a one-time processing step and a definition of a one-time processing process; decomposing and orchestrating a digital content processing process according to the acquired definitions; and processing digital content according to the decomposed and orchestrated digital content processing process. The decomposition and orchestration includes merging multiple same one-time processing steps in at least one one-time processing process into one processing node.

This application claims priority to Chinese Patent Application No. 202210251048.4, filed with the China National Intellectual Property Administration (CNIPA) on Mar. 15, 2022, the disclosure of which is incorporated herein by reference in its entirety.

### TECHNICAL FIELD

This application relates to the field of computer technology, for example, to a digital content processing method, a digital content processing apparatus, an electronic device, a storage medium and a product.

### BACKGROUND

As massive amounts of data continue to be generated and increasingly become an important production resource, digital content processing has also become extremely important. Digital content processing refers to the process of using digital technology to make, label, classify, extract, review, analyze, organize, calculate, edit, and process digital content such as text, images, audios, videos, and data to obtain the final output result.

The technology of digital content processing is to process the digital content according to preset sequence steps and parameters, and use the obtained result as digital content of a next step, and obtain the final output result through a series of steps.

In the related technologies, generally, when to process the same digital content according to business requirements to obtain different results, different processing technologies and parameters are constructed to form processing chains to achieve processing purposes. There will be multiple repeated steps in this process, and the existence of repeated steps may lead to an increase in processing time and a waste of processing resources.

### SUMMARY

A digital content processing method, a digital content processing apparatus, an electronic device, a storage medium and a product are provided according to the present application, to address the issue of repeated steps existing in related technologies.

According to one aspect of the present application, a digital content processing method is provided, which includes as follows.

A definition of a one-time processing step and a definition of a one-time processing process are acquired.

A digital content processing process according to the acquired definitions are decomposed and orchestrated.

Digital content is processed according to the decomposed and orchestrated digital content processing process.

Specifically, the decomposing and orchestrating includes merging multiple same one-time processing steps in at least one one-time processing process into one processing node.

According to another aspect of the present application, a digital content processing apparatus is provided, which includes: an acquisition module, a decomposition and orchestration module and a processing module.

The acquisition module is configured to acquire a definition of a one-time processing step and a definition of a one-time processing process.

The decomposition and orchestration module is configured to decompose and orchestrate a digital content processing process according to the acquired definitions.

The processing module is configured to process digital content according to the decomposed and orchestrated digital content processing process.

The decomposing and orchestrating includes merging multiple same one-time processing steps in at least one one-time processing process into one processing node.

According to another aspect of the present application, an electronic device is provided, the electronic device includes: at least one processor; and a memory.

The memory is communicatively connected to the at least one processor.

The memory stores a computer program that can be executed by the at least one processor, and the computer program is executed by the at least one processor, to enable the at least one processor to execute the digital content processing method described above.

According to another aspect of the present application, a computer-readable storage medium is provided. The computer-readable storage medium stores a computer instruction, and when the computer instruction is executed by a processor, the computer instruction causes the processor to implement the digital content processing method described above.

According to another aspect of the present application, a computer program product is provided. The computer program product includes a computer program, and when the computer program is executed by a processor, the computer program causes the processor to implement the digital content processing method described above.

### BRIEF DESCRIPTION OF DRAWINGS

FIG. 1 is a schematic flowchart of a digital content processing method according to a first embodiment of the present application;

FIG. 2 is a schematic diagram of a one-time processing step in the digital content processing method according to the first embodiment of the present application;

FIG. 3 is a schematic diagram of a one-time processing process in the digital content processing method according to the first embodiment of the present application;

FIG. 4 is a schematic diagram showing decomposition and orchestration of the digital content processing process according to the first embodiment of the present application;

FIG. 5 is a schematic flowchart of a digital content processing method according to a second embodiment of the present application;

FIG. 6 is a schematic flowchart of digital content storing and digital content reading according to the second embodiment of the present application;

FIG. 7 is a schematic flowchart of a digital content processing method according to a third embodiment of the present application;

FIG. 8 is a schematic structural diagram of a digital fingerprint tree according to the third embodiment of the present application;

FIG. 9 is a schematic structural diagram of a digital content processing apparatus according to a fourth embodiment of the present application; and

FIG. 10 is a schematic structural diagram of an electronic device according to a fifth embodiment of the present application.

### DETAILED DESCRIPTION

The technical solutions in the embodiments of the present application are described hereinafter in conjunction with the drawings in the embodiments of the present application, and the described embodiments are only a part of embodiments of the present application rather than all embodiments. Multiple steps described in the method embodiments of the present application may be executed in different orders and/or in parallel. Furthermore, method embodiments may include additional steps and/or omit performance of illustrated steps.

As used herein, the term “include” and its variations are open-ended, i.e., “including but not limited to.” The term “based on” means “based at least in part on.” The term “one embodiment” means “at least one embodiment”; the term “another embodiment” means “at least one additional embodiment”; and the term “some embodiments” means “at least some embodiments”. Relevant definitions of other terms will be given in the description below.

The terms “first”, “second” and the like in the description, claims and drawings of the present application are intended to distinguish between similar objects and are not necessarily used to describe a particular order or sequence. It is to be understood that the data used in this way is interchangeable where appropriate so that the embodiments of the present application described herein may also be implemented in a sequence not illustrated or described herein. Furthermore, terms such as “include”, “have”; and any deformation thereof, are intended to cover non-exclusive inclusion, e.g., a process, method, system, product, or device including a series of steps or units is not necessarily limited to those steps or units expressly listed, but may include other steps or units not expressly listed or inherent to such process, method, system, product or device.

The modifications of “one” and “plurality/multiple” mentioned in the present application are illustrative and not restrictive. The person skilled in the art should understand that unless the context indicates otherwise, it should be understood as “one or more”.

The names of messages or information exchanged between multiple devices in the embodiments of the present application are only for illustrative purposes and are not intended to limit the scope of these messages or information.

### First Embodiment

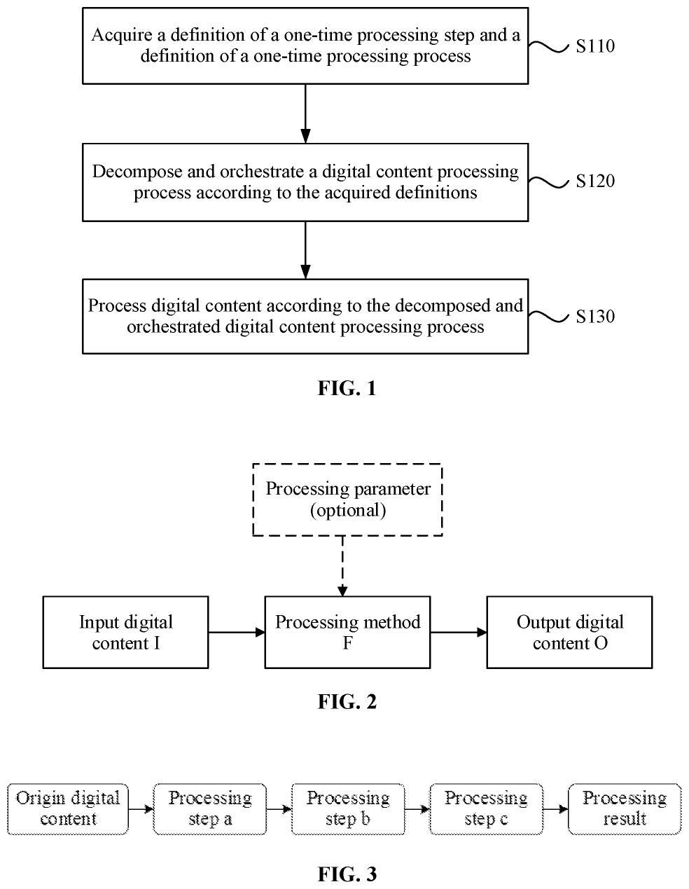

FIG. 1 is a schematic flowchart of a digital content processing method according to a first embodiment of the present application. This method can be applied to the situations where digital content is repeatedly processed through multiple steps. This method can be executed by a digital content processing apparatus, where the apparatus can be implemented by software and/or hardware, and is generally integrated on an electronic device. In this embodiment, the electronic device includes but is not limited to: a computer device.

As shown in FIG. 1, a digital content processing method according to a first embodiment of the present application includes the following steps.

In S110, a definition of a one-time processing step and a definition of a one-time processing process are acquired.

In this embodiment, there is no limitation on how to obtain the definition of a one-time processing step and the definition of a one-time processing process. A feasible way is to define the one-time processing step and the one-time processing process through computer programming, store the defined one-time processing process and the defined one-time processing step into storage. When to process digital content, the definition of a one-time processing step and the definition of a one-time processing process are acquired directly from the storage.

The one-time processing step is defined as taking digital content as input, generating other digital content according to a processing method and a processing parameter and then outputting the generated digital content. The one-time processing process is defined as a process of processing digital content by sequentially at least one one-time processing step to obtain output digital content.

The digital content may include text, images, audio, video and data, etc.

The processing parameter is the processing parameter corresponding to the processing method, that is, when the processing method is determined, the processing parameter is certain. In one embodiment, one processing method and processing parameter can be taken as one transformation method. One-time processing step has a unique certain output for a certain input and transformation method.

FIG. 2 is a schematic diagram of a one-time processing step in the digital content processing method according to the first embodiment of the present application. As shown in FIG. 2, digital content I is input, and the input digital content I is processed through a processing method F and an optional processing parameter P, to obtain output digital content O.

A one-time processing process may include multiple one-time processing steps. FIG. 3 is a schematic diagram of a one-time processing process in the digital content processing method according to the first embodiment of the present application. As shown in FIG. 3, the original digital content is processed through a processing step a, a processing step b and a processing step c to obtain output digital content, where the processing step a, the processing step b and the processing step c are each a one-time processing step, can be the same one-time processing step or different one-time processing steps.

In S120, a digital content processing process is decomposed and orchestrated according to the acquired definitions.

Decomposition and orchestration are automated configuration, management, and coordination for computer systems, applications, and services. Through the orchestration, the computer is enabled to perform specific computing tasks according to conditions and preset flows.

In this embodiment, the process of decomposing and orchestrating may include: orchestrating the digital content processing process into at least one one-time processing process and at least one one-time processing step according to the definition of one-time processing process and the definition of one-time processing step, and merging the same one-time processing steps into one processing node as a processing step shared by all processing processes.

The decomposing and orchestrating the digital content processing process according to the acquired definitions includes: orchestrating the digital content processing process into at least one one-time processing process according to the acquired definitions; decomposing the one-time processing process into at least one one-time processing step; and merging multiple same one-time processing steps into one processing node.

The merging multiple same one-time processing steps into one processing node includes: merging multiple same one-time processing steps in multiple one-time processing processes into one processing node; and merging multiple same one-time processing steps in one processing process into one processing node.

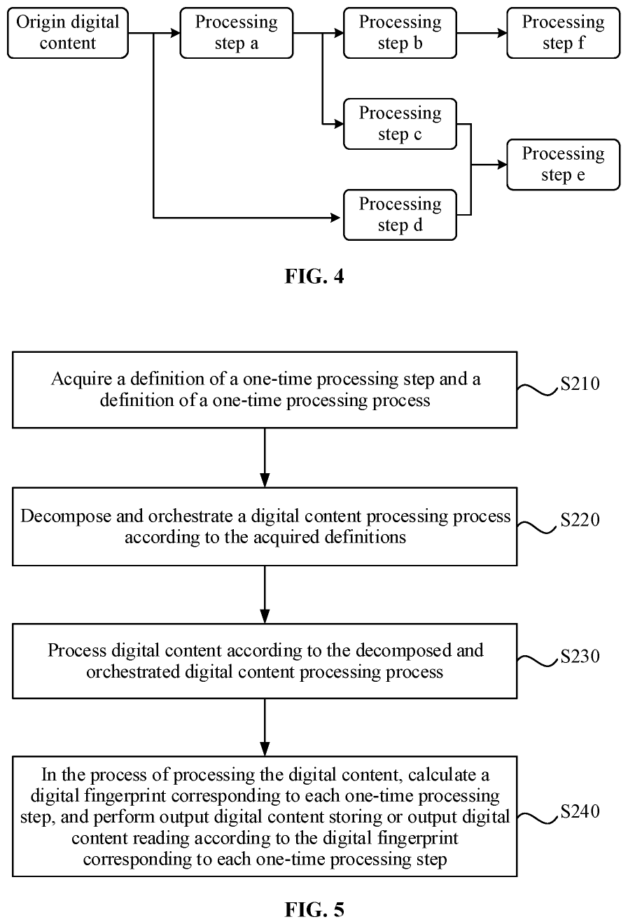

FIG. 4 is a schematic diagram showing decomposition and orchestration of the digital content processing process according to the first embodiment of the present application. As shown in FIG. 4, a processing process A, a processing process B and a processing process C are each a one-time processing process, and a processing step “a” to a processing step “f” are each a one-time processing step. In the processing process A, the original digital content, that is, the input digital content is processed through the processing step “a”, the processing step “b” and the processing step “f” sequentially; in the processing process B, the original digital content is processed through the processing step “a”, the processing step “c”, and the processing step “e” sequentially; and in the processing process C, the original digital content is processed through the processing step “d” and the processing step “e” sequentially. The processing step “a” can be a preceding common step, that is, a processing node, shared by the processing process A and the processing process B; and the processing step “e” can be a posterior common step, that is, a processing node, shared by the processing process B and the processing process C.

In S130, digital content is processed according to the decomposed and orchestrated digital content processing process.

In this embodiment, the digital content processing process, after being decomposed and orchestrated, can form at least one one-time processing process, and in one one-time processing process, the input digital content can be processed through multiple different one-time processing steps sequentially. Different processing processes can share a processing node, and the same steps in multiple one-time processing processes can be processed by one processing node. When the same steps correspond to the same input digital content and the same processing parameters, it is simply required to input the digital content at the processing node for one time, and process the input digital content for one time. When the same steps correspond to different input digital content or different processing parameters, the same steps are all processed at the processing node, and can output different processing results.

For example, as shown in FIG. 4, FIG. 4 shows the digital content processing process after being decomposed and orchestrated. The digital content is processed according to the processing flow in FIG. 4.

In the digital content processing method according to the first embodiment of the present application, first a definition of a one-time processing step and a definition of a one-time processing process are acquired; then a digital content processing process is decomposed and orchestrated according to the acquired definitions; and finally digital content is processed according to the decomposed and orchestrated digital content processing process. The decomposing and orchestrating includes merging multiple same one-time processing steps in at least one one-time processing process into one processing node. In the above method, the digital content processing process is decomposed and orchestrated into multiple one-time processing processes, and multiple same one-time processing steps in multiple one-time processing processes are processed at one time through the processing node obtained after the decomposition and orchestration, thereby, the repeated steps can be effectively reduced, and the processing time and processing resources can be reduced. Thus, the issue of repeated processing of same processing steps is addressed; the beneficial effects of effectively reducing the use of repeated steps, shortening the processing time and reducing the processing resources can be achieved.

Based on the above embodiments, an illustrative embodiment of a digital content processing method is provided. This embodiment is applicable to comprehensive usage scenarios and enables multiple processing processes to be performed synchronously with one digital content input, to reduce repeated processing.

Illustratively, for scenarios where input digital content is uniformly written and processed in daily work, for example, the document management system sequentially performs antivirus operation, illegal content detection, content summary, tag extraction, content image recognition and other processing steps on the files uploaded by the user. The above process can be decomposed and orchestrated according to the definition of one-time processing step and the definition of one-time processing process. After the file is input, the digital content may just be processed according to the digital content processing flow obtained after the decomposition and orchestration, and same steps is performed one time through multiple one-time processing nodes.

### Second Embodiment

FIG. 5 is a schematic flowchart of a digital content processing method according to a second embodiment of the present application, and this second embodiment is described based on the above embodiment. Based on the above embodiment, this embodiment includes: in the process of processing the digital content, a digital fingerprint corresponding to each one-time processing step is calculated, and output digital content storing or output digital content reading is performed according to the digital fingerprint corresponding to each one-time processing step. Reference may be made to the first embodiment for details that are not yet detailed in this embodiment.

As shown in FIG. 5, the digital content processing method according to the second embodiment of the present application includes the following steps.

In S210, a definition of a one-time processing step and a definition of a one-time processing process are acquired.

In S220, a digital content processing process is decomposed and orchestrated according to the acquired definitions.

In S230, digital content is processed according to the decomposed and orchestrated digital content processing process.

In S240, in the process of processing the digital content, a digital fingerprint corresponding to each one-time processing step is calculated, and output digital content storing or output digital content reading is performed according to the digital fingerprint corresponding to each one-time processing step.

In this embodiment, by calculating the digital fingerprint corresponding to each one-time processing step, the corresponding output digital content can be directly obtained according to the stored digital fingerprint, and the obtained output digital content can be used as the input of a subsequent one-time processing step.

Digital fingerprint identification is to use truncated information to identify large data files or structures. Digital fingerprint identification is an algorithm that reduces larger data sets into very small data sets to facilitate effective identification and search protocols. A common fingerprint algorithm is called the hash function. These functions change larger data sets into short data sets. These modified data help make search techniques more agile.

The digital fingerprint includes a first digital fingerprint and a second digital fingerprint. The first digital fingerprint is obtained according to digital content input in a one-time processing step. The second digital fingerprint is obtained according to a processing method and a processing parameter in the one-time processing step.

In this embodiment, each one-time processing step has a digital fingerprint corresponding thereto. One one-time processing step includes input digital content corresponding to the step as well as a processing method and a processing parameter corresponding to the step, therefore, the digital fingerprint may include the first digital fingerprint and the second digital fingerprint. The first digital fingerprint can be a digital fingerprint corresponding to the input digital content, and the second digital fingerprint can be a digital fingerprint corresponding to the processing method and processing parameter.

For example, when the input digital content is input into a one-time processing step, a first digital fingerprint cp(n−1) can be obtained by performing hash calculation on the input digital content; and a second digital fingerprint fp(n) can be obtained by performing hash calculation on the processing method and the processing parameter corresponding to this one-time processing step, where, n represents the step count of the processing step. According to n in the first digital fingerprint and the second digital fingerprint, it can be known which processing step the digital fingerprints correspond to. According to the first digital fingerprint and the second digital fingerprint, output digital content corresponding to this processing step can be obtained.

The performing output digital content storing or output digital content reading according to the digital fingerprint corresponding to each one-time processing step includes: in a case of performing a current one-time processing step, determining whether output digital content corresponding to a digital fingerprint corresponding to the current one-time processing step is included in the storage device; in response to that the output digital content corresponding to the digital fingerprint corresponding to the current one-time processing step is included in the storage device, reading the output digital content from the storage device, and taking the output digital content as an output result of the one-time processing step; and in response to that the output digital content corresponding to the digital fingerprint corresponding to the current one-time processing step is not included in the storage device, processing the to-be-processed digital content by using a processing method and a processing parameter used in the current one-time processing step to obtain an output result, and after marking a digital fingerprint for the output result obtained after the processing, storing the marked output result to the storage device.

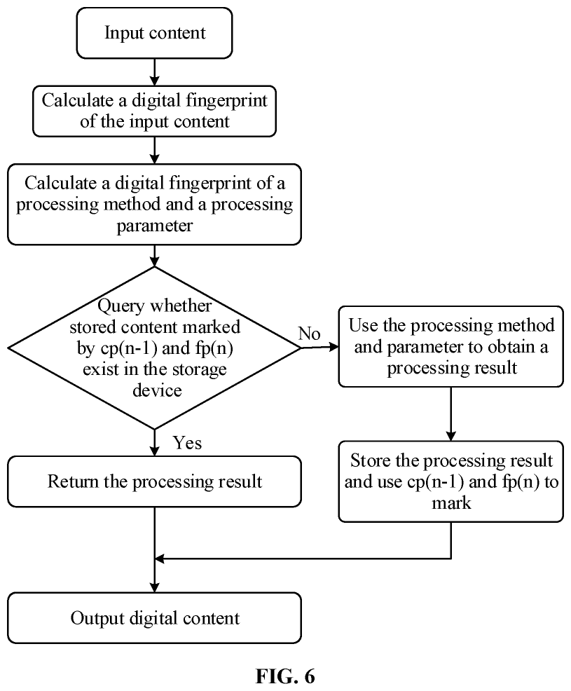

Exemplarily, FIG. 6 is a schematic flow chart of digital content storing and digital content reading according to the second embodiment of the present application. As shown in FIG. 6, when input digital content is input into a one-time processing step, a digital fingerprint cp(n−1), that is, the first digital fingerprint, of the inputted input digital content is calculated; a digital fingerprint fp(n), that is, the second digital fingerprint, of the processing method and the processing parameter is calculated; whether the output digital content marked by the cp(n−1) and fp(n) exist in the storage device is queried, and if the output digital content marked by the cp(n−1) and fp(n) exist in the storage device, the corresponding output digital content is acquired from the storage device and is used as the output result of the one-time processing step; and if the output digital content marked by the cp(n−1) and fp(n) does not exist in the storage device, the inputted digital content is processed by using the processing method and processing parameter corresponding to the one-time processing step, to obtain a processing result, that is, the output digital content, and the processing result is marked by the cp(n−1) and fp(n), and the marked output result is stored to the storage device.

In the digital content processing method according to the second embodiment of the present application, the process of output digital content caching or output digital content reading is performed according to the digital fingerprint. With this method, the output result corresponding to each one-time processing step can be rapidly determined according to the digital fingerprint, without consuming computing resources for processing again.

An illustrative embodiment is provided based on the second embodiment of this application, this illustrative embodiment is applicable to the same enterprise information processing scenario, for example, the processing process of acquiring enterprise information based on the identified taxpayer identification number during invoice identification, and the following processing steps 1, 2, 3 and 4 can be included.

In step 1, an invoice is identified to obtain an identification number of a buyer taxpayer.

In step 2, query is performed based on the identification number of the buyer taxpayer to obtain buyer taxpayer information.

In step 3, the invoice is identified to obtain an identification number of a seller taxpayer.

In step 4, query is performed based on the identification number of the seller taxpayer, to obtain seller taxpayer information.

In the above process, the identification of an invoice a can be regarded as a one-time processing process, a step 2 can be regarded as a one-time processing step, and an identification number of “a” buyer taxpayer “ab” obtained from the identification of the invoice “a” can be used as input digital content. According to the identification number of the buyer taxpayer “ab” in the step 2, calculation is performed to obtain a first digital fingerprint cpab1; and according to the query method and the query parameter in the step 2, calculation is performed to obtain a second digital fingerprint fp2. The cpab1 and fp2 are used to mark an output result of the step 2, that is, buyer taxpayer information, and the marked output result is stored in the storage device. In the above process, a step 4 can be regarded as a one-time processing step, and an identification number of a seller taxpayer “as” obtained from the identification of the invoice “a” can be used as input digital content. According to the identification number of the seller taxpayer “as” in the step 4, calculation is performed to obtain a first digital fingerprint cpas1; and according to the query method and the query parameter in the step 4, calculation is performed to obtain a second digital fingerprint fp2. The cpas1 and fp2 are used to mark an output result of the step 4, that is, seller taxpayer information, and the marked output result is stored in the storage device.

In the above process, the identification of an invoice “b” can be regarded as a one-time processing process, and an identification number of a buyer taxpayer “bb” obtained from the identification of the invoice “b” can be used as input digital content. According to the identification number of the buyer taxpayer “bb” in the step 2, calculation is performed to obtain a first digital fingerprint cpbb1, and the identification number of the seller taxpayer “bs obtained from the identification of the invoice b can be used as input digital content. According to the identification number of the seller taxpayer bs in the step 4, calculation is performed to obtain a first digital fingerprint cpbs1. If the cpbb1 is equal to the cpab1, the output content corresponding to the cpab1 can be directly acquired from the storage device, and if the cpbb1 is not equal to the cpab1, the step 2 is performed for query, cpbb1 and fp2 are used to mark the queried result, and the marked queried result is stored. If the cpbs1 is equal to the cpas1, the output content corresponding to the cpbs1 can be directly acquired from the storage device, and if the cpbs1 is not equal to the cpas1, the step 4 is performed for query, cpbs1 and fp2 are used to mark the quired result, and the marked queried result is.

### Third Embodiment

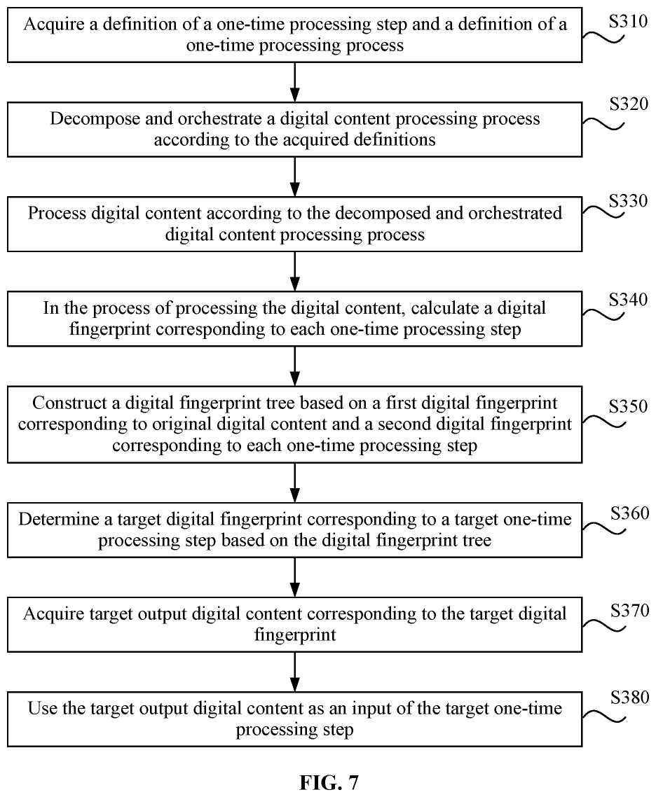

FIG. 7 is a schematic flowchart of a digital content processing method according to a third embodiment of the present application. The third embodiment is described based on the above embodiments. Based on the above embodiments, the digital content processing method according to the third embodiment includes: constructing a digital fingerprint tree based on the digital fingerprint corresponding to each one-time processing step; determining a target digital fingerprint corresponding to a target one-time processing step based on the digital fingerprint tree; reading a target output digital content corresponding to the target digital fingerprint from the storage device; and taking the target output digital content as an input of the target one-time processing step. For contents that are not detailed in this embodiment, please refer to the first embodiment and the second embodiment.

As shown in FIG. 7, a digital content processing method according to the third embodiment of the present application includes the following steps.

In S310, a definition of a one-time processing step and a definition of a one-time processing process are acquired.

In S320, a digital content processing process is decomposed and orchestrated according to the acquired definitions.

In S330, digital content is processed according to the decomposed and orchestrated digital content processing process.

In S340, in the process of processing the digital content, a digital fingerprint corresponding to each one-time processing step is calculated.

In S350, a digital fingerprint tree is constructed based on a first digital fingerprint corresponding to original digital content and a second digital fingerprint corresponding to each one-time processing step.

The original digital content is digital content that has not been processed by any one-time processing step.

In this embodiment, the sequential relationship between digital fingerprints can be built based on a correlation sequence between multiple processing steps to form a digital fingerprint tree with a tree structure.

The constructing a digital fingerprint tree based on a first digital fingerprint corresponding to original digital content and a second digital fingerprint corresponding to each one-time processing step includes: using the first digital fingerprint corresponding to the original digital content as a root node of the digital fingerprint tree; using a second digital fingerprint corresponding to a one-time processing step with a step serial number of 1 in each one-time processing process as a first-layer leaf node of the root node; using a second digital fingerprint corresponding to a one-time processing step with a step serial number of not 1 in each one-time processing process as a leaf node other than the first-layer leaf node, of the root node; and establishing correlation between an output result of each one-time processing step and a corresponding layer leaf node of the respective one-time processing step according to the first digital fingerprint and the second digital fingerprint corresponding to the respective one-time processing step.

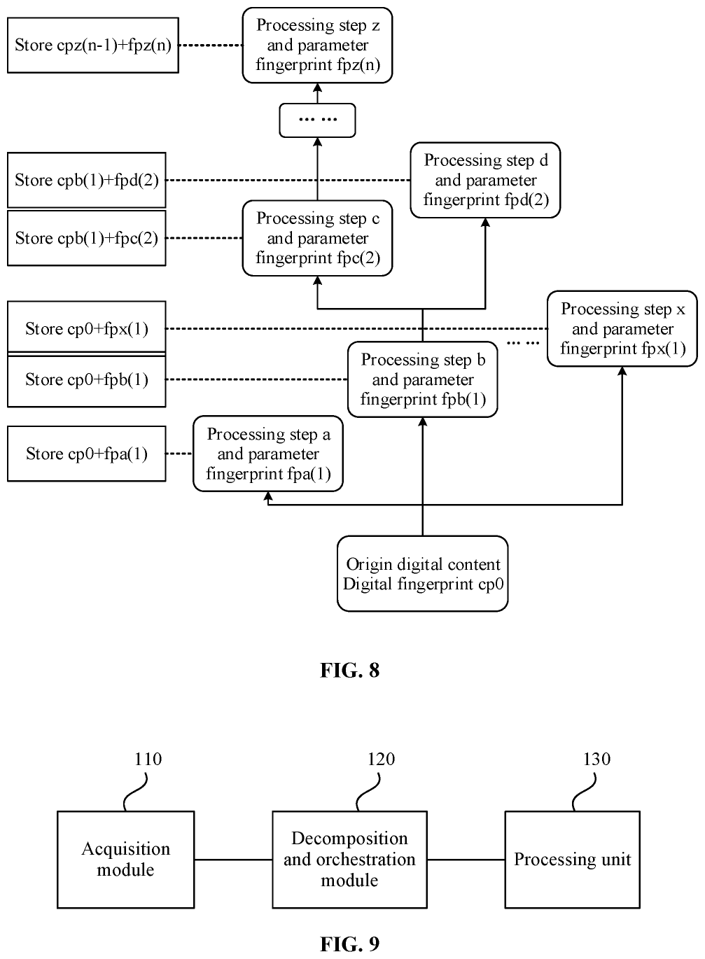

Illustratively, FIG. 8 is a schematic structural diagram of a digital fingerprint tree according to the third embodiment of the present application. As shown in FIG. 8, a first digital fingerprint cp0 corresponding to original digital content is used as a root node of a digital fingerprint tree. A second digital fingerprint fpa(1) of a one-time processing step “a” is used as a first layer leaf node of the digital fingerprint tree, and is correlated with an output result of the one-time processing step “a” marked by cp0+fpa(1). A second digital fingerprint fpb(1) of a one-time processing step “b” is used as a first layer leaf node of the digital fingerprint tree, and is correlated with an output result of the one-time processing step “b” marked by cp0+fpb(1). A second digital fingerprint fpx(1) of a one-time processing step “x” is used as a first layer leaf node of the digital fingerprint tree, and is correlated with an output result of the one-time processing step “x” marked by cp0+fpx(1). A second digital fingerprint fpc(2) of a one-time processing step “c” is used as a second layer leaf node of the digital fingerprint tree, and is correlated with an output result of the one-time processing step “c” marked by cpb(1)+fpc(2). A second digital fingerprint fpd(2) of a one-time processing step “d” is used as a second layer leaf node of the digital fingerprint tree, and is correlated with an output result of the one-time processing step “d” marked by cpb(1)+fpd(2). Layers of leaf nodes are built according to the above flow.

In S360, a target digital fingerprint corresponding to a target one-time processing step is determined based on the digital fingerprint tree.

The target one-time processing step is a processing step whose input is to be confirmed. For example, the target one-time processing step is a processing step subsequent to an interrupted processing step if an interruption occurs. The target one-time processing step may be the same processing steps in the digital content processing process, or may be other processing steps in the digital content processing process.

In an embodiment, when to process the same original digital content, the second digital fingerprints fp of all the one-time processing steps can be calculated, and when compared the second fingerprints fp in the digital fingerprint tree by starting from the root node, a terminal of the matching path that always matches the second digital fingerprints fp can be obtained.

The determining a target digital fingerprint corresponding to a target one-time processing step based on the digital fingerprint tree includes: acquiring all digital fingerprints corresponding to all one-time processing steps prior to the target one-time processing step; determining a matching path based on the all digital fingerprints; matching, the matching path, with the digital fingerprint tree, and using a one-time processing step corresponding to a terminal of the matching path successfully matched in the digital fingerprint tree as an interrupted processing step; and using a digital fingerprint of the interrupted processing step as the target digital fingerprint, where the interrupted processing step is a processing step prior to the target one-time processing step, for example, it may be a processing step during which an interruption occurs.

In S370, target output digital content corresponding to the target digital fingerprint is acquired.

In this embodiment, a correlation between an output result of each one-time processing step and the corresponding layer leaf node is established in the process of constructing the digital fingerprint tree, therefore, a target output digital content corresponding to a target digital fingerprint can be acquired directly based on the correlation.

In S380, the target output digital content is used as an input of the target one-time processing step.

The digital fingerprint tree provided in the third embodiment of the present application can be further used in the case where the digital processing process is interrupted. In the related technology, when the digital processing process is interrupted, it needs to be completely reprocessed. However, in this solution, the interrupted one-time processing step can be located through the digital fingerprint tree, and the output result of the one-time processing step can be directly obtained as the input of the subsequent one-time processing step, that is, when interruption occurs, there is no need to reprocess all steps completely, and it is simply required to continue to process from the step subsequent to the interrupted step.

In processing an interruption, an output result of a one-time processing step with digital content interrupted is located according to the digital fingerprint tree, so that subsequent processing is performed based on the output result of the one-time processing step with the digital content interrupted.

The locating an output result of a one-time processing step with digital content interrupted according to the digital fingerprint tree includes: combining the second digital fingerprints corresponding to all the one-time processing steps prior to the one-time processing step with digital content being interrupted to form a matching path; matching, the matching path, with the digital fingerprint tree; and using an output result corresponding to a one-time processing step corresponding to a terminal of the matching path matched in the digital fingerprint tree as an output result of the one-time processing step with digital content interrupted.

With the digital content processing method according to the third embodiment of the present application, for digital content that needs to be processed by multiple times, by constructing a digital fingerprint tree, the processing results can be quickly obtained and repeated step processing can be reduced; when the digital content processing process is interrupted, the interrupted position can be quickly located through the digital fingerprint tree and the output result at the interrupted position can be directly obtained.

Several illustrative embodiments are provided based on the third embodiment of the present application. As an embodiment, in the scenario where multiple target recognition is performed for pictures, the business requires the recognition of different targets for pictures, such as text and objects, recognition processes of different targets are different and each include multiple steps, and the same processing step in the multiple steps in the recognition processes is image segmentation and binarization, so the image segmentation and binarization step can be used as a processing node for use by multiple one-time processing processes. In the process of image processing, a digital fingerprint cp0 of an original image is recorded, and is directed to original document content in storage; a second digital fingerprint fp1a of an image binarization processing step is recorded; a digital fingerprint tree cp0→fp1a is constructed to establish the correlation between the digital fingerprint and an output result of the image binarization processing step; using the binarization result as an input of a text recognition step to obtain an output result; and using the binarization result as an input of an object recognition step to obtain an output result. In the process of other target recognition processing for images, since the first processing step is also the binarization processing step, an output of the binarization processing step can be obtained directly based on the digital fingerprint tree, and the output result can be used directly.

As another embodiment, the scenario is aimed at generating watermarked portable document format (PDF) documents for different users. When it is required for office format documents commonly used in daily work to be viewed online, it is generally realized by generating PDF format documents. Moreover, for consideration of information security, companies will add watermarks containing personal information to the documents for different users. This digital content processing process consists of two steps: step 1 and step 2.

In a step 1, office format documents are generated into PDF format documents.

In a step 2, different watermark contents are added to the PDF format documents to generate final result documents.

In the process of above processing, different users obtain different final output results, but the output results obtained through the step 1 are consistent, so a digital fingerprint tree can be constructed. The process is as follows:

A first digital fingerprint cp0 of an original office document is recorded, and is directed to original document content in storage. A second digital fingerprint fp1a of the step of generating an office document into a PDF format document is recorded. In generating a watermarked document for a first user “a”, a first digital fingerprint cp1a of the PDF format document obtained in the above step 1 is recorded; a digital fingerprint tree cp0→fp1a is constructed, and cp1a is marked and stored; a second digital fingerprint fp2a of the step of adding a watermark of the first user “a” to the PDF format document is recorded; when the first user “a” requests to generate a watermarked document again, since the second digital fingerprints of the two steps are consistent with the path cp0→fp1a→fp2a, an output result marked with cp2a is directly returned as the final result without further processing.

When to generate a watermarked document for a second user “b”, a second digital fingerprint fp1b of the step of generating the office document into the PDF format document is acquired; since fp1a and fp1b are the same, the output result marked by cp1a is directly obtained without further performing the step 1 for processing. A second digital fingerprint fp2b of the step of adding a watermark of the second user “b” to the PDF format document is acquired. Since fp2a and fp2b are different, it is necessary to reuse the step 2 for watermark adding processing and record the digital fingerprint cp2b of the obtained final document; a digital fingerprint tree fp1→fp2b is constructed, and cp2b is marked and stored. The process of generating watermarked documents for other users can refer to the above process and will not be described in detail here.

### Fourth Embodiment

FIG. 9 is a schematic structural diagram of a digital content processing apparatus according to a fourth embodiment of the present application. The apparatus is applicable to the case of repeatedly processing digital content through multiple steps. The apparatus can be implemented by software and/or hardware, and is generally integrated on an electronic device.

As shown in FIG. 9, the apparatus includes: an acquisition module 110, a decomposition and orchestration module 120 and a processing module 130.

The acquisition module 110 is configured to acquire a definition of a one-time processing step and a definition of a one-time processing process; the decomposition and orchestration module 120 is configured to decompose and orchestrate a digital content processing process according to the acquired definitions; the processing module 130 is configured to process digital content according to the decomposed and orchestrated digital content processing process. The decomposing and orchestrating includes merging multiple same one-time processing steps in at least one one-time processing process into one processing node.

In this embodiment, the apparatus first acquires a definition of a one-time processing step and a definition of a one-time processing process through the acquisition module 110; secondly, decomposes and orchestrates a digital content processing process according to the acquired definitions through the decomposition and orchestration module 120; and finally, processes the digital content according to the decomposed and orchestrated digital content processing process through the processing module 130. The decomposing and orchestrating includes merging multiple same one-time processing steps in at least one one-time processing process into one processing node.

The digital content processing apparatus according to this embodiment can effectively reduce the use of repeated steps, reduce the processing time and processing resources.

In an embodiment, the one-time processing step is defined as taking one piece of digital content as input, outputting other piece of digital content generated according to one processing method and processing parameter. The one-time processing process is defined as a process of processing one piece of digital content by sequentially at least one one-time processing step to obtain output digital content.

In an embodiment, the decomposition and orchestration module 120 is configured to: orchestrate the digital content processing process into at least one one-time processing process according to the acquired definitions; decompose the one-time processing process into at least one one-time processing step; and merge multiple same one-time processing steps into one processing node.

Based on the above technical solution, the apparatus further includes a digital fingerprint calculation module. The digital fingerprint calculation module is configured to, in the process of processing the digital content, calculate a digital fingerprint corresponding to each one-time processing step, and perform output digital content storing or output digital content reading according to the digital fingerprint corresponding to each one-time processing step.

In an embodiment, the digital fingerprint includes a first digital fingerprint and a second digital fingerprint. The first digital fingerprint is obtained according to the digital content input in a one-time processing step. The second digital fingerprint is obtained according to a processing method and a processing parameter in the one-time processing step.

In an embodiment, the digital fingerprint calculation module is configured to: in a case of performing a current one-time processing step, determine whether output digital content corresponding to a digital fingerprint corresponding to the current one-time processing step is included in the storage device; in response to that the output digital content corresponding to a digital fingerprint corresponding to the current one-time processing step is included in the storage device, read the output digital content from the storage device, and take the output digital content as an output result of the one-time processing step; and in response to that the output digital content corresponding to a digital fingerprint corresponding to the current one-time processing step is not included in the storage device, process the to-be-processed digital content by using a processing method and a processing parameter used in the current one-time processing step to obtain an output result, and after marking a digital fingerprint for the output result obtained after the processing, store the marked output result to the storage device.

In an embodiment, the apparatus further includes a digital fingerprint tree module. The digital fingerprint tree module is configured to construct a digital fingerprint tree based on a first digital fingerprint corresponding to original digital content and a second digital fingerprint corresponding to each one-time processing step, and the original digital content being digital content that has not been processed by any one-time processing step; determine a target digital fingerprint corresponding to a target one-time processing step based on the digital fingerprint tree; acquire a target output digital content corresponding to the target digital fingerprint; and take the target output digital content as an input of the target one-time processing step.

The digital fingerprint tree module is configured to construct a digital fingerprint tree based on the digital fingerprint corresponding to each one-time processing step by: using the first digital fingerprint corresponding to the original digital content as a root node of the digital fingerprint tree; using a second digital fingerprint corresponding to a one-time processing step with a step serial number of 1 in each one-time processing process as a first-layer leaf node of the root node; using a second digital fingerprint corresponding to a one-time processing step with a step serial number of not 1 in each one-time processing process as a leaf node, other than the first-layer leaf node, of the root node; and establishing correlation between an output result of each one-time processing step and a corresponding layer leaf node of the respective one-time processing step according to the first digital fingerprint and the second digital fingerprint corresponding to the respective one-time processing step.

The digital fingerprint tree module is configured to determine a target digital fingerprint corresponding to a target one-time processing step based on the digital fingerprint tree by: acquiring all digital fingerprints corresponding to all one-time processing steps prior to a target one-time processing step; determining a matching path based on the all digital fingerprints; matching, the matching path, with the digital fingerprint tree, and using a one-time processing step corresponding to a terminal of the matching path successfully matched in the digital fingerprint tree as an interrupted processing step; and using a digital fingerprint of the interrupted processing step as the target digital fingerprint.

The above-described digital content processing apparatus can implement the digital content processing method according to any embodiment of the present application, and has corresponding functional modules for performing the method and has corresponding effects to the effects achieved by performing the method.

### Fifth Embodiment

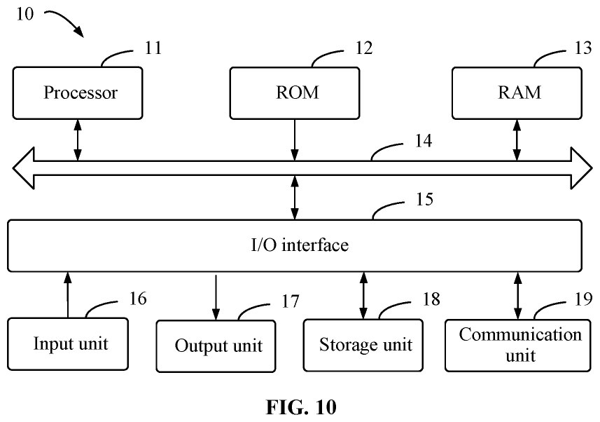

FIG. 10 shows a schematic structural diagram of an electronic device 10 that can be used to implement an embodiment of the present application. It is intended to use electronic device 10 to represent various forms of digital computers, such as laptops, desktops, workstations, personal digital assistants, servers, blade servers, mainframes, and other suitable computers. Electronic devices 10 may further represent various forms of mobile devices, such as personal digital processing, cellular phones, smart phones, wearable devices (e.g., helmets, glasses, watches, etc.), and other similar computing devices. The components shown herein, their connections and relationships, and their functions, are used as examples only, and are not intended to limit implementations of the applications described and/or claimed herein.

As shown in FIG. 10, the electronic device 10 includes at least one processor 11, and a memory communicatively connected with the at least one processor 11, such as a read-only memory (ROM) 12, a random access memory (RAM) 13, etc., where the memory stores a computer program executable by at least one processor, and the processor 11 can perform various appropriate actions and processes according to a computer program stored in the ROM 12 or a computer program loaded from a storage unit 18 into the RAM 13. In the RAM 13, various programs and data necessary for the operation of the electronic device 10 may further be stored. The processor 11, ROM 12, and RAM 13 are connected to each other through a bus 14. An input/output (I/O) interface 15 is also connected to the bus 14.

Multiple components in the electronic device 10 are connected to the I/O interface 15, include: an input unit 16, such as a keyboard, a mouse, etc.; an output unit 17, such as various types of displays, speakers, etc.; a storage unit 18, such as a magnetic disk, an optical disk etc.; and a communication unit 19, such as a network card, a modem, a wireless communication transceiver, and the like. The communication unit 19 allows the electronic device 10 to exchange information/data with other devices through a computer network such as the Internet and/or various telecommunication networks.

The processor 11 may be various general and/or special purpose processing components having processing and computing capabilities. Some examples of the processor 11 include, but are not limited to, a central processing unit (CPU), a graphics processing unit (GPU), various dedicated artificial intelligence (AI) computing chips, various processors that run machine learning model algorithms, digital signal processing processors (DSP), and any suitable processor, controller, microcontroller, etc. The processor 11 performs the various methods and processes described above, such as the digital content processing method.

In some embodiments, the digital content processing method can be implemented as a computer program, which is tangibly contained in a computer-readable storage medium, for example, a storage unit 18. In some embodiments, part or all of the computer program may be loaded and/or installed on the electronic device 10 via the ROM 12 and/or the communication unit 19. When the computer program is loaded into the RAM 13 and performed by the processor 11, one or more steps of the digital content processing method described above can be performed. Optionally, in other embodiments, the processor 11 may be configured in any other appropriate way (for example, by means of firmware) to perform the digital content processing method.

Various implementations of the system and technique described above herein can be implemented in a digital electronic circuit system, an integrated circuit system, a field programmable gate array (FPGA), an application specific integrated circuit (ASIC), application specific standard parts (ASSPs), a system on chip (SOC), a complex programming logic device (CPLD), a computer hardware, firmware, software, and/or combinations thereof. These various embodiments may include being implemented in one or more computer programs which can be performed and/or interpreted on a programmable system including at least one programmable processor, the programmable processor can be a special-purpose or general-purpose programmable processor, can receive data and instruction from storage system, at least one input device, and at least one output device, and transmit data and instruction to the storage system, the at least one input device, and the at least one output device.

The one or more computer programs for implementing the method of the present application may be written in one programming language or any combination of more programming languages. These computer programs can be provided to a processor of a general-purpose computer, a special-purpose computer or other programmable data processing apparatus, so that the computer programs, when being performed by the processor, causes the functions/operations specified in the flowchart and/or block diagram to be implemented. The computer programs may be performed entirely on the machine, partly on the machine, partly on the machine and partly on a remote machine as a stand-alone software package, or entirely on a remote machine or remote server.

In the context of the present application, a computer readable storage medium may be a tangible medium that may contain or store a computer program for use by an instruction execution system, apparatus or device or use in conjunction with an instruction execution system, apparatus or device. A computer readable storage medium may include, but is not limited to, an electronic, magnetic, optical, electromagnetic, infrared, or semiconductor system, apparatus, or device, or any suitable combination of the foregoing. Optionally, a computer readable storage medium may be a machine readable signal medium. More specific examples of machine-readable storage media would include one or more wire-based electrical connected or portable computer discs, hard drives, RAM, ROM, erasable programmable read-only memory (EPROM) or flash memory, optical fiber, compact disk read-only memory (CD-ROM), optical storage, magnetic storage, or any suitable combination of the foregoing.

In order to provide interaction with the user, the systems and techniques described herein can be implemented on an electronic device having a display device (e.g., a cathode ray tube (CRT) or liquid crystal display (LCD)) configured to display information to the user; and a keyboard and a pointing device (e.g., a mouse or a trackball) through which the user can provide input to the electronic device. Other kinds of devices can also be configured to provide interaction with the user; for example, the feedback provided to the user can be any form of sensory feedback (e.g., visual feedback, auditory feedback, or tactile feedback); and can be in any form (including acoustic input, speech input or, tactile input) to receive input from the user.

The systems and techniques described herein can be implemented in a computing system that includes back-end components (e.g., as a data server), or a computing system that includes middleware components (e.g., an application server), or a computing system that includes front-end components (e.g., a user computer having a graphical user interface or web browser through which a user can interact with embodiments of the system and technique described herein), or be implemented in a computing system including any combination of such backend components, middleware components, or front-end components. The components of the system can be interconnected by any form or medium of digital data communication, (e.g., a communication network). Examples of communication network include: local area networks (LANs), wide area network (WAN), blockchain network, and the Internet.

A computing system can include a client and a server. The client and the server are generally remote from each other and typically interact through a communication network. The relationship of the client and the server arises by computer programs running on the respective computers and having a client-server relationship to each other. The server can be a cloud server, also known as a cloud computing server or a cloud host, and is a host product in the cloud computing service system to overcome the drawbacks of difficult management and weak business expansion in traditional physical hosts and virtual private servers VPSs.

Steps may be reordered, added or deleted using the various forms of flow shown above. For example, multiple steps described in the present application may be performed in parallel, sequentially, or in a different order, as long as the desired result of the technical solution of the present application can be achieved, which is not limited herein.

1. A digital content processing method, executed by an apparatus comprising at least one processor and a storage device, comprising:
acquiring a definition of a one-time processing step and a definition of a one-time processing process;
decomposing and orchestrating a digital content processing process according to the acquired definition of the one-time processing step and the acquired definition of the one-time processing process; and
processing digital content according to the decomposed and orchestrated digital content processing process,
wherein, the decomposing and orchestrating comprises merging a plurality of same one-time processing steps in at least one one-time processing process into one processing node.

2. The method according to claim 1, wherein the one-time processing step is defined as taking one digital content as input, outputting other digital content generated according to processing method and processing parameter and then outputting it, and the one-time processing process is defined as processing one digital content by sequentially at least one one-time processing step to obtain output digital content.

3. The method according to claim 2, wherein the decomposing and orchestrating a digital content processing process according to the acquired definitions comprises:
orchestrating a digital content processing process into at least one one-time processing process according to the acquired definitions;
decomposing the at least one one-time processing process into at least one one-time processing step; and
merging a plurality of same one-time processing steps in the at least one one-time processing step into the processing node.

4. The method according to claim 1, further comprising:
in the process of processing the digital content, calculating a digital fingerprint corresponding to each one-time processing step, and performing output digital content storing or output digital content reading according to the digital fingerprint corresponding to each one-time processing step.

5. The method according to claim 4, wherein the digital fingerprint comprises a first digital fingerprint and a second digital fingerprint, the first digital fingerprint is obtained according to digital content input in a one-time processing step, and the second digital fingerprint is obtained according to a processing method and a processing parameter in the one-time processing step.

6. The method according to claim 4, wherein the performing output digital content storing or output digital content reading according to the digital fingerprint corresponding to each one-time processing step comprises:
in a case of performing a current one-time processing step, determining whether output digital content corresponding to a digital fingerprint corresponding to the current one-time processing step is comprised in a storage device;
in response to that the output digital content corresponding to the digital fingerprint corresponding to the current one-time processing step is comprised in the storage device, reading the output digital content from the storage device, and taking the output digital content as an output result of the one-time processing step; and
in response to that the output digital content corresponding to the digital fingerprint corresponding to the current one-time processing step is not comprised in the storage device, processing a to-be-processed digital content by using a processing method and a processing parameter used in the current one-time processing step to obtain an output result, and marking a digital fingerprint for the output result, storing the marked output result to the storage device.

7. The method according to claim 4, further comprising:
constructing a digital fingerprint tree based on a first digital fingerprint corresponding to original digital content and a second digital fingerprint corresponding to each one-time processing step, wherein the original digital content is digital content that has not been processed by any one-time processing step;
determining a target digital fingerprint corresponding to a target one-time processing step based on the digital fingerprint tree;
acquiring a target output digital content corresponding to the target digital fingerprint; and
taking the target output digital content as an input of the target one-time processing step.

8. The method according to claim 7, wherein the constructing a digital fingerprint tree based on a first digital fingerprint corresponding to original digital content and a second digital fingerprint corresponding to each one-time processing step comprises:
using the first digital fingerprint corresponding to the original digital content as a root node of the digital fingerprint tree;
using a second digital fingerprint corresponding to a one-time processing step with a step serial number of 1 in each one-time processing process as a first-layer leaf node of the root node;
using a second digital fingerprint corresponding to a one-time processing step with a step serial number of not 1 in each one-time processing process as a leaf node, other than the first-layer leaf node, of the root node; and
establishing correlation between an output result of each one-time processing step and a corresponding layer leaf node of the respective one-time processing step according to the first digital fingerprint and the second digital fingerprint corresponding to the respective one-time processing step.

9. The method according to claim 7, wherein the determining the target digital fingerprint corresponding to the target one-time processing step based on the digital fingerprint tree comprises:
acquiring all digital fingerprints corresponding to all one-time processing steps prior to the target one-time processing step;
determining a matching path based on the all digital fingerprints;
matching, the matching path, with the digital fingerprint tree, and using a one-time processing step corresponding to a terminal of the matching path successfully matched in the digital fingerprint tree as an interrupted processing step; and
using a digital fingerprint of the interrupted processing step as the target digital fingerprint.

10. A digital content processing apparatus, comprising a processor and a memory for storing execution instructions that when executed by the processor cause the processor to perform steps in following modules:
an acquisition module configured to acquire a definition of a one-time processing step and a definition of a one-time processing process;
a decomposition and orchestration module configured to decompose and orchestrate a digital content processing process according to the acquired definitions; and
a processing module configured to process digital content according to the decomposed and orchestrated digital content processing process,
wherein the decomposition and orchestration comprises merging a plurality of same one-time processing steps in at least one one-time processing process into one processing node.

11. An electronic device, comprising:
at least one processor; and
a memory communicatively connected to the at least one processor; wherein,
the memory stores a computer program executable by the at least one processor, the computer program is executed by the at least one processor, to enable the at least one processor to execute the digital content processing method according to claim 1.

12. A non-transitory computer-readable storage medium, storing a computer instruction, wherein the computer instruction is used to cause a processor to implement the digital content processing method according to claim 1 when the computer instruction is executed by the processor.

13. (canceled)

14. The electronic device according to claim 11, wherein the digital content processing method further comprising:
in the process of processing the digital content, calculating a digital fingerprint corresponding to each one-time processing step, and performing output digital content storing or output digital content reading according to the digital fingerprint corresponding to each one-time processing step.

15. The electronic device according to claim 14, wherein the digital fingerprint comprises a first digital fingerprint and a second digital fingerprint, the first digital fingerprint is obtained according to digital content input in a one-time processing step, and the second digital fingerprint is obtained according to a processing method and a processing parameter in the one-time processing step.

16. The electronic device according to claim 14, wherein the performing output digital content storing or output digital content reading according to the digital fingerprint corresponding to each one-time processing step comprises:
in a case of performing a current one-time processing step, determining whether output digital content corresponding to a digital fingerprint corresponding to the current one-time processing step is comprised in a storage device;
in response to that the output digital content corresponding to the digital fingerprint corresponding to the current one-time processing step is comprised in the storage device, reading the output digital content from the storage device, and taking the output digital content as an output result of the one-time processing step; and
in response to that the output digital content corresponding to the digital fingerprint corresponding to the current one-time processing step is not comprised in the storage device, processing a to-be-processed digital content by using a processing method and a processing parameter used in the current one-time processing step to obtain an output result, and marking a digital fingerprint for the output result, storing the marked output result to the storage device.

17. The electronic device according to claim 14, wherein the digital content processing method further comprising:
constructing a digital fingerprint tree based on a first digital fingerprint corresponding to original digital content and a second digital fingerprint corresponding to each one-time processing step, wherein the original digital content is digital content that has not been processed by any one-time processing step;
determining a target digital fingerprint corresponding to a target one-time processing step based on the digital fingerprint tree;
acquiring a target output digital content corresponding to the target digital fingerprint; and
taking the target output digital content as an input of the target one-time processing step.

18. The electronic device according to claim 17, wherein the constructing a digital fingerprint tree based on a first digital fingerprint corresponding to original digital content and a second digital fingerprint corresponding to each one-time processing step comprises:
using the first digital fingerprint corresponding to the original digital content as a root node of the digital fingerprint tree;
using a second digital fingerprint corresponding to a one-time processing step with a step serial number of 1 in each one-time processing process as a first-layer leaf node of the root node;
using a second digital fingerprint corresponding to a one-time processing step with a step serial number of not 1 in each one-time processing process as a leaf node, other than the first-layer leaf node, of the root node; and
establishing correlation between an output result of each one-time processing step and a corresponding layer leaf node of the respective one-time processing step according to the first digital fingerprint and the second digital fingerprint corresponding to the respective one-time processing step.

19. The electronic device according to claim 17, wherein the determining the target digital fingerprint corresponding to the target one-time processing step based on the digital fingerprint tree comprises:
acquiring all digital fingerprints corresponding to all one-time processing steps prior to the target one-time processing step;
determining a matching path based on the all digital fingerprints;
matching, the matching path, with the digital fingerprint tree, and using a one-time processing step corresponding to a terminal of the matching path successfully matched in the digital fingerprint tree as an interrupted processing step; and
using a digital fingerprint of the interrupted processing step as the target digital fingerprint.

20. The non-transitory computer-readable storage medium according to claim 12, wherein the digital content processing method further comprising:
in the process of processing the digital content, calculating a digital fingerprint corresponding to each one-time processing step, and performing output digital content storing or output digital content reading according to the digital fingerprint corresponding to each one-time processing step.

21. The non-transitory computer-readable storage medium according to claim 20, wherein the digital fingerprint comprises a first digital fingerprint and a second digital fingerprint, the first digital fingerprint is obtained according to digital content input in a one-time processing step, and the second digital fingerprint is obtained according to a processing method and a processing parameter in the one-time processing step.
